(19) United States
(12) Patent Application Publication
(10) Pub. No.: US 2016/0207830 A1
(43) Pub. Date: Jul. 21, 2016

(54) AIR ENTRAINING AGENT FOR MINERAL BINDER COMPOSITIONS

(71) Applicant: SIKA TECHNOLOGY AG, Baar (CH)

(72) Inventors: Christian BÜRGE, Schafisheim (CH); Franz WOMBACHER, Jonen (CH); Christophe KURZ, Endingen (CH)

(73) Assignee: SIKA TECHNOLOGY AG, Baar (CH)

(21) Appl. No.: 14/912,293

(22) PCT Filed: Jul. 24, 2014
(86) PCT No.: PCT/EP2014/065941

§ 371 Date: Feb. 16, 2016

(30) Foreign Application Priority Data
Aug. 15, 2013 (EP) 13180573.1

(51) Int. Cl. C04B 22/04; C04B 28/08; C04B 28/04

(52) U.S. Cl. CPC C04B 22/04; C04B 28/04; C04B 28/08; C04B 2103/42

(57) ABSTRACT

A method for producing a mineral binder composition, in particular a concrete or mortar composition. At least one mineral binder is prepared using water, and an air entraining agent is added prior to and/or during the preparation of the mineral binder composition. The air entraining agent includes a particulate reducing agent with an average particle size of at least 25 μm.

### TECHNICAL FIELD

The invention relates to a method for producing a mineral binder composition, more particularly a concrete or mortar composition, in which at least one mineral binder is mixed with water and in which before and/or during the mixing of the mineral binder composition an air entrainer is added. The invention further pertains to the use of the air entrainers for introducing air pores and/or improving the freeze/de-icing salt resistance in mineral binders. Furtherer aspects of the invention relate to a composition comprising an air entrainer and also to a minerally binder composition.

### PRIOR ART

Mineral binder compositions such as concrete and mortar in particular must be aerated in order, for example, to improve workability or in order to achieve sufficient freeze/de-icing salt resistance.

One of the properties of water is to expand on freezing. In binder compositions, therefore, on cooling below 0° C., liquid water is displaced by freezing water, and a hydrostatic pressure is generated. If the tensile strength of the binder composition is exceeded, the consequences are instances of flaking or even the destruction of the system.

If an air entrainer is added to the binder composition during mixing, stable air pores can be produced, which are present in the binder composition even after curing.

The prior art has disclosed various air entrainers, examples being various cationic, anionic and nonionic surfactants or else tall oil (see WO 95/26936, CH 689619 and DE 195 28 912, for example).

Also in use in practice are solid air entrainers such as the product Sika® Aer Solid (Sika Schweiz AG), for example, which consist of polymer-clad hollow air beads.

The known air entrainers, however, have various disadvantages. A particular problem is the customarily relatively high metering sensitivity of the air entrainers. Thus the required amount of air entrainers is customarily heavily dependent on the mixing operation, on the binder used, on the aggregates, on the quality of the mixing water, on the transport time, or on the viscosity during processing of the binder composition.

When using liquid air entrainers, specifically, it is necessary to adjust the metering separately for each application, and comprehensive quality control must be performed. This gives rise to considerable effort and to corresponding costs.

More recent products such as Sika® Aer Solid have the advantage over the liquid air entrainers that the air pores are added already in prefabricated form and therefore that the sensitivity in relation to binder, for example, is lower. A disadvantage, however, is that some of the solid air pores are destroyed during the mixing operation. This fraction varies according to mixer type, mixing time, mixture viscosity, and the form of the aggregates.

Achieving adequate freeze/de-icing salt resistance in mineral binders is therefore relatively costly and inconvenient with the measures known to date. As a result, there continues to be a need for new solutions for improving the freeze/de-icing salt resistance of mineral binder compositions, such solutions having the aforementioned disadvantages to as small an extent as possible or not at all.

### Outline of the Invention

It is an object of the present invention, therefore, to overcome the disadvantages described above. The aim therewith is to provide new solutions for improving the freeze/de-icing salt resistance of mineral binder compositions. The solutions in particular are to operate as far as possible independently of the particular processing method or of the specific binder composition, and are to allow the production of mineral binder compositions having a very high freeze/de-icing salt resistance.

Surprisingly it has been found that this can be achieved by the method for producing a mineral binder composition as claimed in claim 1.

The core of the present invention, accordingly, is the use of a reducing agent in particle form as air entrainer, the average particle size of the reducing agent being less than 25 μm. The air entrainer is added beforehand and/or during mixing to at least one component of the mineral binder composition.

Surprisingly it has emerged that as a result it is possible to achieve excellent freeze/de-icing salt resistances in various mineral binder compositions. This may be attributable to an extremely uniformly distribution of the air pores with a defined size in the range of 20-300 μm (diameter). The air entrainers here function essentially independently of the respective binder composition and of the specific mixing technique. The metering sensitivity is therefore correspondingly low, producing reliable control over the freeze/de-icing salt resistance.

Further aspects of the invention are subject matter of further independent claims. Particularly preferred embodiments of the invention are subject matter of the dependent claims.

### Ways of Performing the Invention

In a first aspect, the present invention comprises a method for producing a mineral binder composition, more particularly a concrete or mortar composition, preferably having a density of ≧1.0 kg/dm³, in which at least one mineral binder is mixed with water and in which before and/or during the mixing of the mineral binder composition an air entrainer is added, the air entrainer comprising a reducing agent in particle form having an average particle size of less than 25 μm.

The term “air entrainers” in this context stands in particular for a substance which when present or added during the production of a mineral binder composition, generates air pores in the mineral binder composition. The air pores are, in particular, substantially stable during the mixing operation and the processing of the mineral binder composition. The term “air” should be interpreted broadly in the present context, encompassing all substances which are gaseous under standard conditions.

A “reducing agent” refers presently in particular to material capable of reducing water. The reducing agent advantageously possesses a standard potential or reduction potential of less than −0.7 V, more particularly less than −0.9 V, preferably less than −1.5 V, especially in the range from −0.9 to −2.5 V, relative to the standard hydrogen electrode under standard conditions (T=298.15 K; p=1 atm; ionic activity=1).

The reducing agent is used in particle form. This means that the reducing agent comprises a multiplicity of individual particles. This reducing agent may be present as or used in the form of a solid, such as a powder, a liquid, for example in the form of a suspension or slurry, or in the form of a paste or a suspension with high solids content. A suspension, a slurry, or a paste may comprise, for example, water and/or one or more organic solvents, such as one or more glycols, for example.

The particle size, its distribution, or the average particle size of the reducing agent are determined in particular by means of laser diffraction, preferably in accordance with standard ISO 13320:2009. Use is made more particularly of a Mastersizer 2000 instrument with a Hydro 2000G dispersing unit and the Mastersizer 2000 software, from Malvern Instruments GmbH (Germany). An example of a suitable measuring medium is isopropanol. The average particle size corresponds presently in particular to the D50 (50% of the particles are smaller than the stated value, 50% accordingly, larger).

The term “density” refers presently in particular to the specific gravity. The density or specific gravity is determined in particular in accordance with standard EN 1015-6.

The expression “mineral binder composition” refers present in particular to a composition comprising at least one mineral binder and also, optionally aggregates, adjuvants, admixtures and/or water. In principle, moreover, there may also be further components present in the mineral binder composition, an example being reinforcing fibers. The mineral binder composition can be mixed by addition of water and mixing to form a curable mineral binder composition. In principle the mineral binder composition may be liquid, pasty, or in solid state.

The mineral binder composition is more particularly a cementitious binder composition. A “cementitious binder” or a “cementitious binder composition” refers presently in particular to a binder or a binder composition having a cement fraction of at least 5 wt %, more particularly at least 20 wt %, preferably at least 50 wt %, especially at least 75 wt %.

A mineral binder is a binder which in the presence of water reacts in a hydration reaction to form solid hydrates or hydrate phases. It may be, for example, a hydraulic binder (e.g. cement or hydraulic lime), a latent hydraulic binder (e.g. slag), a pozzolanic binder (e.g. fly ash), or a non-hydraulic binder (e.g. gypsum or white lime).

The mineral binder or the binder composition in particular comprises a hydraulie binder, preferably cement. Particularly preferred is cement of type CEM I, II, III or IV (as per standard EN 197-1). A fraction of the hydraulic binder as a proportion of the overall mineral binder is advantageously at least 5 wt %, more particularly at least 20 wt %, preferably at least 50 wt %, especially at least 75 wt %. According to another advantageous embodiment, the mineral binder comprises at least 95 wt % of hydraulic binder, more particularly cement.

It may, however, also be advantageous for the binder composition to comprise other binders as well as or instead of a hydraulic binder. Such binders are, in particular, latent hydraulic binders and/or pozzolanic binders. Suitable latent hydraulic and/or pozzolanic binders are, for example, slag, fly ash and/or silica dust. The binder composition may also comprise inert materials such as finely ground limestone, finely ground quartz and/or pigments, for example. In one advantageous embodiment, the mineral binder comprises 5-95 wt %, more particularly 20-50 wt %, of latent hydraulic and/or pozzolanic binders.

Without being tied to the theory, it is assumed that the reducing agent reacts with the mixing water in redox reactions during the mixing of the mineral binder composition. One of the products of such reactions is hydrogen which provides in turn for the formation of pores in the mineral binder composition.

It was found here that in order to achieve good freeze/de-icing salt resistance it is critical for the average particle size of the reducing agent to measure <25 μm, more particularly <20 μm. If an average particle size of 25 μm is exceeded, there is a significant drop in particular in the freeze/de-icing salt resistance. This may be attributable to inadequate distribution of the pores in the binder matrix and to a pore size distribution that is not suitable for the achievement of freeze/de-icing salt resistance.

According to a further-preferred embodiment, an average particle size of the reducing agent is 0.1-20 μm, more particularly 0.2-18 μm, preferably 0.5 μm, in particular 1-10 μm. With very particular preference the average particle size is 2-8 μm.

In particular the D90 of the particle size of the reducing agent is 25 μm, more particularly 20 μm, especially 15 μm, especially preferably 10 μm or 8 μm. In other words, 90% of the particles of the reducing agent in particular are smaller than 25 μm, more particularly smaller than 20 μm, especially smaller than μm, especially preferably smaller than 10 μm or smaller than 8 μm.

The D10 of the particle size of the reducing agent is preferably 0.1 μm, more particularly 0.5 μm, especially 1 μm or 3 μm. In other words, 10% of the particles of the reducing agent are in particular less than 0.1 μm, more particularly less than 0.5 μm, especially less than 1 μm or less than 2 μm.

A sieve residue of the particles of the reducing agent ≧45 μm is preferably less than 1 wt %, more preferably less than 0.5 wt %, more preferably still less than 0.2 wt % or less than 0.1 wt %.

Such particle sizes are particularly advantageous in relation to the freeze/de-icing salt resistance. It has emerged, moreover, that in these cases the distribution of pore sizes is extremely homogeneous.

The reducing agent preferably comprises a metal, more particularly a nonnoble metal. The metal is preferably selected from the group consisting of aluminum, magnesium, manganese, zinc and/or vanadium. Also possible here in particular are combinations of a plurality of different metals. Metals presently are in particular in the 0 (zero) oxidation state. Salts or metal oxides, accordingly, are not included under the term “metals”.

In particular the reducing agent comprises aluminum or consists of it. This aluminum is, more particularly, metallic aluminum and not an aluminum salt. Aluminum as reducing agent has emerged as being particularly judicious since it is particularly advantageous in relation to the freeze/de-icing salt problem, is simple to handle, and can be incorporated well into mineral binder compositions by mixing.

Depending on requirements, however, other metals as well, or other nonmetallic reducing agents, may be suitable.

With advantage, the reducing agent is added with a fraction of 0.0005-0.1 wt %, preferably 0.001-0.05 wt %, more particularly 0.002-0.03 wt %, especially 0.002-0.02 wt % or 0.0025-0.01 wt %, based on the binder content of the binder composition. This produces an optimum pore distribution and further improves the freeze/de-icing resistance.

In praxis it has emerged that a reducing agent comprising or consisting of pulverulent aluminum having an average particle size of 0.1-20 μm, in particular 0.1-18 μm, more particularly 0.1-15 μm, preferably 1-10 μm or 2-8 μm, is very advantageous for many applications.

The reducing agent ideally consists of or comprises pulverulent aluminum having an average particle size of 2-8 μm, which is added more particularly with a fraction of 0.002-0.01 wt %, based on the binder content of the mineral binder composition.

According to another preferred embodiment, the reducing agent is added as part of a mixture with at least one filling material.

Filling material suitably includes, for example, chalks, fly ashes, silica fume, slag, slag sands, gypsum, calcium carbonate, burnt lime, hydraulic powder, e.g. cement, a latent hydraulic power, pozzolans, inert powders or mixtures thereof. An especially preferred filling material is calcium carbonate.

Ideally the mixture contains 0.1-10 wt %, more particularly 0.5-5 wt %, of the reducing agent and 90-99.9 wt %, more particularly 95-99.5 wt %, of the at least one filling material.

Given that even small amounts of reducing agent are sufficient for effective pore formation, the reducing agent can be provided in a form with better handling qualities for practice through being mixed with a filling material. As a resuit, in particular, the metering of the reducing agent is simplified.

The reducing agent and/or a mixture comprising the reducing agent may be added to the mineral binder composition, for example, before, during and/or after the addition of the mixing water. The mineral binder composition in this case may for example already be in dry or wet premixed form.

An alternative possibiliity is to premix the reducing agent and/or a mixture comprising the reducing agent with one or more components of the mineral binder composition, the binder, for example, and then to mix up the mineral binder composition in a conventional way.

In the solid aggregate state, the reducing agent and/or a mixture comprising the reducing agent may also, for example, be part of what is called a dry mix, which can be stored for a very long time and which is typically packaged in sacks or stored in silos prior to use.

The reducing agent and/or a mixture comprising the reducing agent may also be mixed beforehand with a further admixture, such as a plasticizer, for example, in the form of a suspension, a slurry, or a solids mixture. That mixture can then be added, again conventionally, during the mixing of the mineral binder composition.

As further admixtures it is possible to use plasticizers, such as, for example, lignosulfonates, sulfonated naphthalene-formaldehyde condensates, sulfonated melamine-formaldehyde condensates and/or polycarboxylate ethers (PCE). Polycarboxylate ether-based plasticizers (PCE) are particularly preferred here. The further admixtures may also comprise, for example, accelerators, corrosion inhibitors, pigments, retardants, shrinkage reducers, defoamers and/or foam formers.

Specific substances which may be used as further admixtures are, for example, thiocyanates, thiolufates, sulfates, nitrates, nitrites, hydroxides, acetates, formates, chlorides, glycerol, amino alcohols, organic acids, inorganic acids and/or latex.

One possible achievement of combination with a further admixture is the acquisition of multi-functional admixtures.

A further aspect of the present invention relates to the use of a reducing agent in particle form, more particularly a reducing agent as presently described, for the introduction of air pores into a mineral binder composition, more particularly a concrete or mortar composition, and/or for improving the freeze/de-icing salt resistance of the mineral binder composition.

The improvement in the freeze/de-icing salt resistance is determined in particular in accordance with standard SIA 262-1 Annex C and in relation to a correspondingly reference sample without air entrainer.

The invention further relates to a composition comprising a reducing agent in particle form having an average particle size of less than 25 μm, and also at least one further component selected from a filling material, aggregates, a mineral binder and/or a concrete admixture.

The reducing agent here is defined in particular as described above.

Accordingly, in the composition, the reducing agent advantageously comprises pulverulent aluminum having a particle size of 0.1-20 μm, more particularly 0.1-15 μm, preferably 1-10 μm or 2-8 μm. Very preferably the reducing agent consists of or comprises pulverulent aluminum having an average particle size of 2-8 μm.

The at least one further component in the composition is more particularly a filling material, preferably calcium carbonate.

Ideally the composition contains 0.1-10 wt %, more particularly 0.5-5 wt %, of the reducing agent and 90-99.9 wt %, more particularly 95-99.5 wt %, of the at least one filling material.

A further aspect of the present invention pertains to a mineral binder composition. The mineral binder composition may be present, for example, in liquid, paste-like or solid state.

The mineral binder composition comprises at least one mineral binder and also a composition as described above that comprises a reducing agent in particle form having an average particle size of less than 25 μm and also at least one further component selected from a filling material, aggregates, a binder and/or a concrete admixture.

The mineral binder composition may also be obtained by a method as described above for producing a mineral binder composition.

A weight ratio of water to binder (“w/c”) during mixing of the mineral binder composition is advantageously 0.2-0.8, more particularly 0.3-0.6, more particularly 0.35-0.55.

The pH during the production of the mineral binder composition is in the basic range, preferably in the range ≧8, more preferably in the range ≧10 or ≧12.

The mineral binder composition 6 minutes after mixing preferably has an air content of at least 4%, preferably at least 4.5%, especially preferably 4%-10%. The air content here is determined preferably in accordance with standard EN 1015-7.

A density of the mineral binder composition, more particularly in the cured state, is more particularly ≧1.0 kg/dm³, preferably ≧1.5 kg/dm³, especially ≧2.0 kg/dm³, more preferably 2.1-2.6 kg/dm³.

In particular the mineral binder composition is not a lightweight concrete composition or a mineral binder composition with a density <1.5 kg/dm³ or <1.0 kg/dm³.

The mineral binder composition advantageously meets exposure class XF1, preferably XF2, more particularly XF3, very preferably XF4 as relevant for the freeze/de-icing salt resistance in accordance with standard EN 206-1.

A further aspect of the invention relates to a cured shaped body, more particularly an edifice or part of an edifice, comprising a water-cured mineral binder composition as described above.

Further advantageous embodiments of the invention are apparent from the working examples below.

### WORKING EXAMPLES

### Provision of an Air Pore-Forming Composition

In order to produce an air pore-forming composition, 1 wt % of aluminum powder (reducing agent) having an average particle size (D50) of 5 μm and a sieve residue at 45 μm of <0.1 wt % (available from Benda-Lutz, Austria) was mixed with 99 wt % of pulverulent calcium carbonate (product “Neckafill”, available from Kalkfabrik Netstal, Switzerland). The pulverulent mixture is referred to below as air entrainer LP-1.

As a reference, a 1 wt % aluminum powder having an average particle size of 40 μm und 99 wt % calcium carbonate air entrainer was prepared. This pulverulent mixture is referred to below as air entrainer LP-R.

The average particle size (D50) was determined in accordance with standard ISO 13320:2009 using a Mastersizer 2000 instrument, a Hydro 2000G dispersing unit, and the Mastersizer 2000 software from Malvern Instruments GmbH (Germany) with isopropanol as measuring medium.

### Mortar Tests

The activity of the air entrainers LP and LP-R was tested in various mortar mixtures. Table 1 lists the general dry composition of the mortar mixture used.

TABLE 1
Dry composition of the mortar mixture

| Mortar mixture composition | |
|---|---|
| (maximum grain size 8 mm) | Quantity in g |
| Cement (for type see below) | 750 |
| Limestone filler | 141 |
| Sand 0-1 mm | 738 |
| Sand 1-4 mm | 1107 |
| Sand 4-8 mm | 1154 |

In a first mortar mixture MM1, a CEM I 42.5 N Portland cement (1:1:1 mixture of Swiss cement grades Holcim, Vigier, Jura cement) having a Blaine fineness of about 3′400 cm²/g was used.

A second mortar mixture MM2, a CEM III A 32.5 N blast furnace cement (Holcim, Modero 3A) was used.

For the mixing of mortar compositions, the sands, the limestone filler, and the respective cement of the mortar mixture were mixed dry in a Hobart mixer for 1 minute. Over the course of 10 seconds, the mixing water, in which additionally a concrete plasticizer had been dissolved or dispersed, and also the air entrainer LP-1 or LP-R, respectively, were added and mixing was carried out for a further 170 seconds. The total wet mixing time was 3 minutes. The water/cement index (w/c) was 0.43 for MM1 and 0.39 for MM2.

Added to all of the mortar compositions, additionally, was a concrete plasticizer (Sika® Viscocrete® 3010-S; available from Sika Schweiz AG) in order to improve the workability of the mortar compositions. For MM1 0.8 wt % and for MM2 0.7 wt % of the concrete plasticizer was used, based in each case on the cement weight.

One minute after the mixing of the mortar compositions, the respective slump flow (SF) was determined in accordance with standard EN 1015-3.

The testing for determining the freeze/de-icing salt resistance (FDR) took place on cubes (15×15×15 cm at 20° C.) in accordance with standard SIA 262-1Annex C.

The specific gravity and the air content were determined 6 minutes after mixing in accordance with standards EN 1015-6 (specific gravity) and EN 1015-7 (air content).

The results of the mortar tests are summarized in tables 2 (for mortar mixture MM1) and 3 (for mortar mixture MM2). R1 is a reference sample, produced similarly to the other mortar mixtures on the basis of MM1 but without addition of an air entrainer. R3 is a corresponding reference sample based on MM2.

TABLE 2
Results of mortar tests with mortar mixture MM1

| | Air entrainer/ | | | | |
|---|---|---|---|---|---|
| | level of | | | | |
| | addition | SF | Specific gravity | Air content | FDR* |
| Sample | [wt %] | [mm] | [g/dm³] | [%] | [gm²] |
| R1 | — | 185 | 2370 | 3.1 | 1300 |
| R2 | LP-R/0.75 | 196 | 2327 | 5.0 | 1100 |
| A | LP-1/0.25 | 197 | 2321 | 5.2 | 300 |
| B | LP-1/0.50 | 198 | 2310 | 5.9 | 100 |
| C | LP-1/0.75 | 196 | 2320 | 5.8 | 20 |
| D | LP-1/1.00 | 195 | 2293 | 7.1 | 80 |

TABLE 3
Results of mortar tests with mortar mixture MM2

| | Air entrainer/ | | | | |
|---|---|---|---|---|---|
| | level of | | | | |
| | addition | SF | Specific gravity | Air content | FDR* |
| Sample | [wt %] | [mm] | [g/dm³] | [%] | [gm²] |
| R3 | — | 191 | 2352 | 3.3 | 1540 |
| R4 | LP-R/0.75 | 192 | 2320 | 4.5 | 1250 |
| E | LP-1/0.25 | 188 | 2335 | 4.8 | 410 |
| F | LP-1/0.50 | 195 | 2310 | 5.4 | 130 |
| G | LP-1/0.75 | 195 | 2319 | 5.6 | 40 |
| H | LP-1/1.00 | 193 | 2297 | 6.8 | 60 |

*The smaller the measured value, the better the freeze/de-icing salt resistance.

The results of the mortar tests show that the addition of air entrainer based on aluminum powder with an average particle size <25 μm produces an effective and constant air input of more than 4.0% and at the same time achieves excellent freeze/de-icing salt resistance on the part of the mortar mixtures. This is so irrespective of the type of binder used.

In contrast, when using coarse-grained air entrainers (samples R2 and R4), the results include, in particular, substantially poorer freeze/de-icing salt resistances.

The working examples above, however, represent only illustrative actualizations of the invention, which may be modified arbitrarily within the invention.

Thus, for example, aluminum powder can be combined in the air entrainer LP1 with a different reducing agent, such as with magnesium powder, for example, or may be replaced entirely by the other reducing agent.

It is also possible, for example, to replace calcium carbonate in the air entrainer LP-1 by a different filling material or to omit the filling material entirely.

Additionally, for example, the aluminum powder or the air entrainer LP-1 can be premixed with a component of the dry mortar mixture, such as with dry cement or dry aggregates, for example.

It is conceivable, furthermore, for the aluminum powder to be suspended in the concrete plasticizer or in another concrete admixture instead of being mixed with the calcium carbonate. By this means a multifunctional admixture can be provided.

In conclusion, therefore, it can be stated that an extremely advantageous method and also products suitable therefor have been provided for the introduction of air pores into mineral binder compositions and for the production of binder compositions having high freeze/de-icing salt resistance.

1. A method for producing a mineral binder composition having a density of ≧1.0 kg/dm³, in which at least one mineral binder is mixed with water and in which before and/or during the mixing of the mineral binder composition an air entrainer is added, wherein the air entrainer comprises a reducing agent in particle form having an average particle size of less than 25 μm.

2. The method as claimed in claim 1, wherein an average particle size of the reducing agent is 0.1-20 μm.

3. The method as claimed in claim 1, wherein the reducing agent comprises a metal selected from the group consisting of aluminum, magnesium, manganese, zinc, and/or vanadium.

4. The method as claimed in claim 1, wherein the reducing agent consists of or comprises aluminum.

5. The method as claimed claim 1, wherein the reducing agent is added with a fraction of 0.0005-0.1 wt % based on the binder content of the binder composition.

6. The method as claimed in claim 1, wherein the reducing agent comprises pulverulent aluminum having an average particle size of 2-8 μm which is added with a fraction of 0.002-0.01 wt %, based on the binder content of the mineral binder composition.

7. The method as claimed in claim 1, wherein the reducing agent is added as part of a mixture with at least one filling material.

8. The method as claimed in claim 7, wherein the mixture contains 0.1-10 wt % of the reducing agent and 90-99.9 of the at least one filling material.

9. A reducing agent in a particle form having an average particle size of less than 25 μm, as claimed in claim 1 is used for introducing air pores into a mineral binder composition, and/or for improving the freeze/de-icing salt resistance of the mineral binder composition.

10. A composition comprising a reducing agent in a particle form having an average particle size of less than 25 μm and also at least one further component selected from a filling material, aggregates, a binder and/or a concrete admixture.

11. The composition as claimed in claim 10, wherein the reducing agent comprises pulverulent aluminum having an average particle size of 0.1-18 μm.

12. The composition as claimed in claim 10, wherein at least one further component is a filling material, and where 0.1-10 wt % of the reducing agent and 90-99.9 wt % of the at least one filling material are present.

13. A mineral binder composition comprising at least one mineral binder and also a composition as claimed in claim 10 or obtainable by a method having a density of ≧1.0 kg/dm³, in which at least one mineral binder is mixed with water and in which before and/or during the mixing of the mineral binder composition an air entrainer is added, wherein the air entrainer comprises a reducing agent in particle form having an average particle size of less than 25 μm.

14. The mineral binder composition as claimed in claim 13, a density of the mineral binder composition being ≧1.0 kg/dm³.

15. A cured shaped article comprising a water-cured mineral binder composition as claimed in claim 13.
